(19) United States
(12) Patent Application Publication
(10) Pub. No.: US 2022/0305725 A1
(43) Pub. Date: Sep. 29, 2022

(54) THREE-DIMENSIONAL PRINTING METHOD ENABLING THREE-DIMENSIONAL PRINTING ON ONE AREA OF BED, AND THREE-DIMENSIONAL PRINTER USED THEREIN

(71) Applicant: KOREA INSTITUTE OF MACHINERY & MATERIALS, Daejeon (KR)

(72) Inventors: Changwoo LEE, Daejeon (KR); Taeho HA, Daejeon (KR); Segon HEO, Daejeon (KR); Hyeonseop SHIN, Daejeon (KR); Pil-Ho LEE, Seoul (KR)

(21) Appl. No.: 17/608,813

(22) PCT Filed: Jul. 30, 2020
(86) PCT No.: PCT/KR2020/010034

§ 371 Date: Nov. 4, 2021

(30) Foreign Application Priority Data
Jul. 31, 2019 (KR) 10-2019-0093237

(51) Int. Cl. B29C 64/153; B33Y 10/00; B33Y 30/00; B33Y 50/02; B29C 64/393; B29C 64/214; B22F 10/28; B22F 10/85; B22F 12/67

(52) U.S. Cl. CPC B29C 64/153; B33Y 10/00; B33Y 30/00; B33Y 50/02; B29C 64/393; B29C 64/214; B22F 10/28; B22F 10/85; B22F 12/67

(57) ABSTRACT

In a three-dimensional printing method using a three-dimensional printer, a powder material is integrated on a partial area of a bed of the printer. A laser is irradiated to the integrated powder material based on a two-dimensional shape information of a manufactured structure, to sinter a two-dimensional structure and a first wall layer. The integrating and the irradiating are repeated, to form a three-dimensional structure and the first wall layer. The first wall layer is disposed to divide the partial area of the bed into a remaining area of the bed except for the partial area of the bed.

### BACKGROUND

### 1. Field of Disclosure

The present disclosure of invention relates to a three-dimensional printing method enabling three-dimensional printing on one area of bed and a three-dimensional printer used therein, and more specifically the present disclosure of invention relates to a three-dimensional printing method enabling three-dimensional printing on one area of bed and a three-dimensional printer used therein, capable of decreasing an amount of powder materials used for the printing and capable of decreasing a speed of the printing, via using a partial area of a printing bed in manufacturing a three-dimensional structure.

### 2. Description of Related Technology

A three-dimensional printing technology is widely used for various kinds of industrial fields, since the technology is very effective in manufacturing a complex three-dimensional structure more easily and the technology is suitable for small quantity production of various kinds. As a three-dimensional printing type using a metal powder, PBF (powder bed fusion) is widely used.

In the PBF, the metal powder is integrated layer by layer on a flat surface, and a laser is irradiate to sinter the metal powder for manufacturing the structure. Thus, the manufacturing process and the operation are relatively easy and the three-dimensional structure having a relatively high density is manufactured more easily.

FIG. 1 is a plan view illustrating a partial element of the conventional PBF type three-dimensional printer. In the conventional three-dimensional printer, a scraper 2 is used to integrate a powder material 3 on a bed 1 of the printer thinly. Here, the scraper 2 moves a round trip from a first side of the bed 1 to a second side of the bed 1 by a moving distance D, to integrate the powder material 3 on the bed 1 with a thickness between about 30 μm and about 50 μm, and then the laser is irradiated to sinter the powder material 3, so that the structure 5 is manufactured. Then, a bottom surface of the bed 1 descends between bout 30 μm and about 50 μm, and the scraper 2 integrates the powder material 3 on the bed 1 again, and then the laser is irradiated again to manufacture the structure. Further, the above-mentioned processes are repeated to manufacture the structure completely.

However, in the conventional three-dimensional printing process, the powder material may be wasted unnecessarily in manufacturing the structure 5 having a relatively small size. The powder material should be integrated over all area of the bed 1 regardless of the size of the structure, to manufacture the structure with a uniform density, and thus even though the size of the bed is relatively large and the size of the structure is relatively small, the powder material should be integrated repeatedly all over the area of the bed 1 at every sintering process. Thus, the powder material may be wasted unnecessarily. In addition, at every sintering process, the scraper 2 should be moved with the round trip over the bed 1 for integrating the powder material, and thus the manufacturing process needs relatively large time, even though the structure is relatively small. Thus, the productivity may be decreased.

Related prior art is Korean patent No. 10-1855184.

### SUMMARY

The present invention is developed to solve the above-mentioned problems of the related arts. The present invention provides a three-dimensional printing method, capable of decreasing an amount of powder materials used for the printing and capable of decreasing a speed of the printing.

In addition, the present invention also provides a three-dimensional printer used in the three-dimensional printing method.

According to an example embodiment, in a three-dimensional printing method using a three-dimensional printer, a powder material is integrated on a partial area of a bed of the printer. A laser is irradiated to the integrated powder material based on a two-dimensional shape information of a manufactured structure, to sinter a two-dimensional structure and a first wall layer. The integrating and the irradiating are repeated, to form a three-dimensional structure and the first wall layer. The first wall layer is disposed to divide the partial area of the bed into a remaining area of the bed except for the partial area of the bed.

In an example, in the integrating, a scraper may move to be a round trip from a predetermined waiting position to a predetermined return position (round trip distance, d) passing through the first wall layer.

In an example, before the integrating, a predetermined amount of the powder material may be discharged between the waiting position of the scraper and the bed, from a material supplier. The predetermined amount of the powder material may be determined based on the round trip distance d of the scraper.

In an example, the first wall layer may be formed to enclose at least two side surfaces of the three-dimensional structure.

In an example, the first wall layer may have a grid shape in a plan view, and the powder material may be filled in a space of the grid shape.

In an example, the first wall layer may become inclined toward the three-dimensional structure as a height of the first wall layer goes up, when forming the first wall layer.

In an example, a second wall layer may be formed with the three-dimensional structure and the first wall layer at the same time. The second wall layer may be adjacent to the first wall layer, and the first wall layer may be disposed between the second wall layer and the three-dimensional structure.

In an example, the second wall layer may become inclined toward the first wall layer as a height of the second wall layer goes up, when forming the second wall layer.

According to an example embodiment, a three-dimensional printer for forming a three-dimensional structure includes a bed, a material supplier, a scraper, a laser irradiation device and a controller. The bed is configured to be enclosed by a liftable based plate and a sidewall of a body of the printer. The material supplier is configured to supply a powder material to the bed. The scraper is configured to integrate the powder material from the material supplier on the bed. The laser irradiation device is configured to irradiate the powder material integrated on the bed, to sinter the powder material. The controller is configured to control the scraper and the laser irradiation device. The controller controls the scraper and the laser irradiation device, such that the powder material is integrated on a partial area of the bed and the laser is irradiated to the integrated powder material, to form a three-dimensional structure and a first wall layer. The first wall layer is disposed to divide the partial area of the bed into a remaining area of the bed except for the partial area of the bed.

In an example, the controller may control such that the scraper moves to be a round trip from a predetermined waiting position to a predetermined return position (round trip distance, d) passing through the first wall layer.

In an example, the controller may control such that the material supplier determines the predetermined amount of the powder material based on the round trip distance d of the scraper.

In an example, the first wall layer may be formed to enclose at least two side surfaces of the three-dimensional structure.

In an example, the first wall layer may have a grid shape in a plan view, and the powder material may be filled in a space of the grid shape.

In an example, the controller may control such that a second wall layer is formed with the three-dimensional structure and the first wall layer at the same time. The second wall layer may be adjacent to the first wall layer, and the first wall layer may be disposed between the second wall layer and the three-dimensional structure.

In an example, the second wall layer may become inclined toward the first wall layer as a height of the second wall layer goes up.

According to the present example embodiments, in manufacturing a three-dimensional structure, the powder material should not be integrated on an entire area of the bed, and thus the powder material may not be wasted unnecessarily. In addition, the moving distance of the scraper may be decreased, to increase the speed of the manufacturing.

### BRIEF DESCRIPTION OF THE DRAWINGS

FIG. 1 is a plan view illustrating the conventional three-dimensional printer;

FIG. 2 is a schematic view illustrating a three-dimensional printer according to an example embodiment of the present invention;

FIG. 3A, FIG. 3B, FIG. 3C, FIG. 3D, FIG. 4A, FIG. 4B, FIG. 4C and FIG. 4D are process views illustrating a three-dimensional printing method using the printer in FIG. 2;

FIG. 5 and FIG. 6 are plan views illustrating an example disposition of a structure and a wall layer, in a three-dimensional printing method using a three-dimensional printer according to another example embodiment of the present invention;

FIG. 7A is a plan view illustrating a wall layer in a three-dimensional printing method using a three-dimensional printer according to still another example embodiment of the present invention, and FIG. 7B is an enlarged view illustrating a portion ‘A’ of FIG. 7A;

FIG. 8A is a plan view and FIG. 8B is a side view illustrating a three-dimensional printing method using a three-dimensional printer according to still another example embodiment of the present invention;

FIG. 9 is a plan view illustrating a three-dimensional structure and a wall layer, in a three-dimensional printing method using a three-dimensional printer according to still another example embodiment of the present invention;

FIG. 10A and FIG. 10B are plan views illustrating a three-dimensional structure and a wall layer, in a three-dimensional printing method using a three-dimensional printer according to still another example embodiment of the present invention;

FIG. 11A and FIG. 11B are plan views illustrating a three-dimensional printing method using a three-dimensional printer according to still another example embodiment of the present invention;

FIG. 12A is a side view illustrating a three-dimensional structure and a wall layer in a three-dimensional printing method using a three-dimensional printer according to still another example embodiment of the present invention, and FIG. 12B is an enlarged view illustrating the wall layer of FIG. 12A;

FIG. 13A, FIG. 13B, FIG. 13C and FIG. 13D are process views illustrating an example method for integrating the wall layer, in the three-dimensional printing method in FIG. 12A and FIG. 12B; and

FIG. 14A, FIG. 14B, FIG. 14C and FIG. 14D are process views illustrating another example method for integrating the wall layer, in the three-dimensional printing method in FIG. 12A and FIG. 12B.

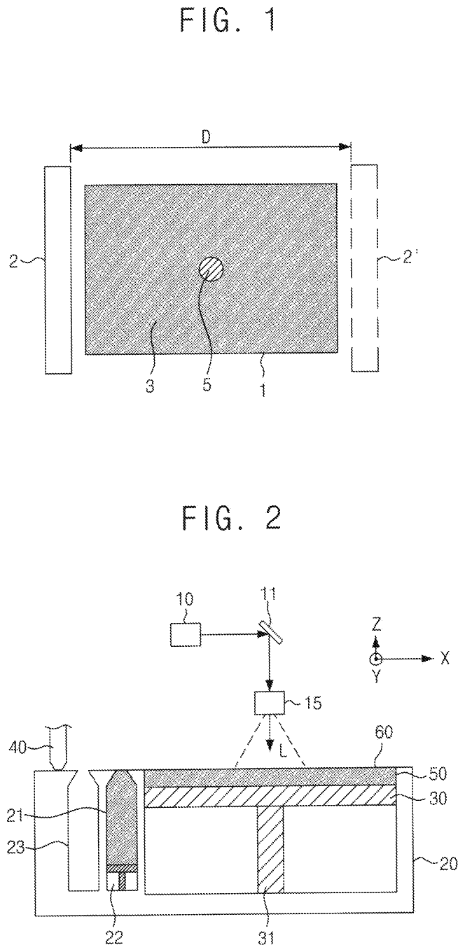

### REFERENCE NUMERALS

| | |
|---|---|
| 10: laser output device | 11: mirror |
| 15: laser irradiation device | 20: body |
| 21: material supplier | 23: material collector |
| 30: base plate | 40: scraper |
| 50: bed | 60: powder material |
| 70: structure | 80, 81: wall layer |

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this invention belongs.

Hereinafter, example embodiments of the present invention are explained in detail referring to the figures. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The three-dimensional printer in the example embodiments of the present invention is explained as the PBF (powder bed fusion) type printer. In the PBF type printer, the high energy beam (such as a laser beam or an electron beam) is irradiated to the powder type material for the sintering, to manufacture the product. The PFB type may be called as the SLS (selective laser sintering) type, a DMLS (direct metal laser sintering) type, a SLM (selective laser melting) type, or an EBM (electron beam melting) type. Thus, the three-dimensional printer in the example embodiments may not be limited to the PBF type printer, and may be applied to any type of three-dimensional printer manufacturing the product via sintering the powder material.

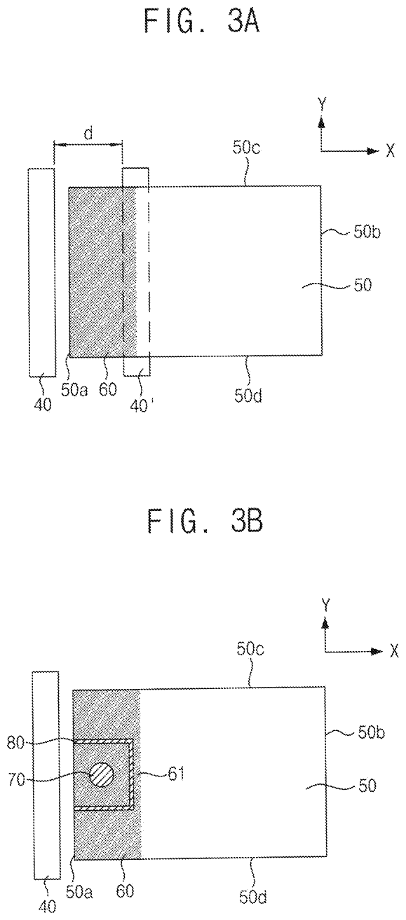

FIG. 2 is a schematic view illustrating a three-dimensional printer according to an example embodiment of the present invention.

Referring to FIG. 2, the three-dimensional printer (hereinafter, printer) includes a laser output device 10, a laser irradiation device 15, and a body 20. The body 20 includes a material supplier 21, a material collector 23, a scraper 40 and a bed 50.

The laser output device 10 outputs a laser for sintering a powder material 60, and the laser output device 10 may include a laser generating part configured to generate the laser. Alternatively, the laser output device 10 may be a transmitting device for transmitting the laser generated by the laser generating part (not shown) to the laser irradiation device 15.

The laser is used for sintering the powder material, and the laser may include an Nd:YAG laser having a power between about 30W and 1,000W or preferably about 500W, but not limited thereto. Thus, the laser having various kinds of wavelengths and powers may be used.

The laser L outputted from the laser output device 10 is transmitted to the laser irradiation device 15, through at least one optical element such as a mirror 11 or an optical fiber. The laser irradiation device 15 irradiates the laser L to the powder material 60 integrated on a bed 50, to sinter the powder material 60, and thus a three-dimensional structure is manufactured (or printed). For example, the laser irradiation device 15 may be performed as a Galvano scanner, and a direction of the laser is controlled to be focused on any position inside of a printing area.

Although not shown in the figure, the printer may further include a moving device moving the laser irradiation device 15 along a plane (X-Y plane) parallel with the bed 50. Here, the moving device may further move the laser irradiation device 15 along a vertical direction (Z axis direction).

As mentioned above, the body 20 includes a material supplier 21, a material collector 23, a scraper 40 and a bed 50.

The material supplier 21 stores the powder material 60 and discharges a predetermined amount of the powder material 60 upwardly. For example, as illustrated in FIG. 2, a lifting part 22 is equipped at a lower portion of the material supplier 21, and the lifting part 22 lifts the material supplier 21 by a predetermined distance to discharge the predetermined amount of the powder material 60 outwardly.

The powder material 60 may be any powder material capable of being sintered by a laser. For example, the powder material 60 may be a metal power or a plastic resin powder.

Alternatively, the material supplier 21 may be equipped with a plural, and thus at least two materials may be used as the powder material 60.

The bed 50 is equipped at the body 20, to receive the powder material 60. Here, an inner area of the bed 50 is defined by a base plate 30 disposed below and a sidewall of the body 20 having four side surfaces. The base plate 30 may move up and down by a lifting member 31. Initially, the base plate 30 is positioned at the same height with an upper surface of the body 20, and the base plate 30 moves downwardly between about 30 μm and about 50 μm at once. Here, as the base plate 30 moves downwardly at once, the powder material 60 is discharged on the upper surface of the body 20 from the material supplier 21, and then the scraper 40 pushes the discharged powder material 60 toward the bed 50, so that the powder material 60 is coated on the upper surface of the base plate 30. In FIG. 2, the scraper 40 disposed at a left end of the body 20 moves toward a right end of the body 20 with a round trip, to coat the powder material 60 on the upper surface of the base plate 30 uniformly, and then the remained powder material not used on the coating is returned to the material collector 23. Accordingly, as the powder material is integrated on the bed 50 layer by layer, the laser irradiation device 15 irradiates the laser L to the powder material based on the shape information of a two-dimensional structure repeatedly, and then the three-dimensional structure is manufactured.

In the body 20 of the printer, the structures and the dispositions of the material supplier 21, the material collector 23 and the bed 50 may be variously changed according to example embodiments. For example, as illustrated in FIG. 2, the material supplier 21 and the material collector 23 may be disposed at a left side of the bed 50, but alternatively, the material supplier 21 and the material collector 23 may be respectively disposed at both left and right sides of the bed 50. Further, the material supplier 21 may be disposed on the body 20 instead of being buried inside of the body 20, or the material supplier 21 may be disposed inside of the scraper 40. Here, the powder material 60 may be dropped on the surface of the body 20 from an upper portion of the body 20.

Alternatively, although not shown in the figure, the printer may further include a controller. The controller may control each operation of the laser output device 10, the laser irradiation device 15, the lifting part 22, the lifting member 31, the scraper 40 and so on.

For example, the controller may control an intensity of the laser outputted by the laser output device 10, an on/off of the laser, a direction of the laser form the laser irradiation device 15, a moving operation of the laser irradiation device 15, an up/down moving of the lifting part 22, an amount of the powder material supplied at every coating, an up/down moving and a moving height of the lifting member 31, an operation of the scraper 40, and so on.

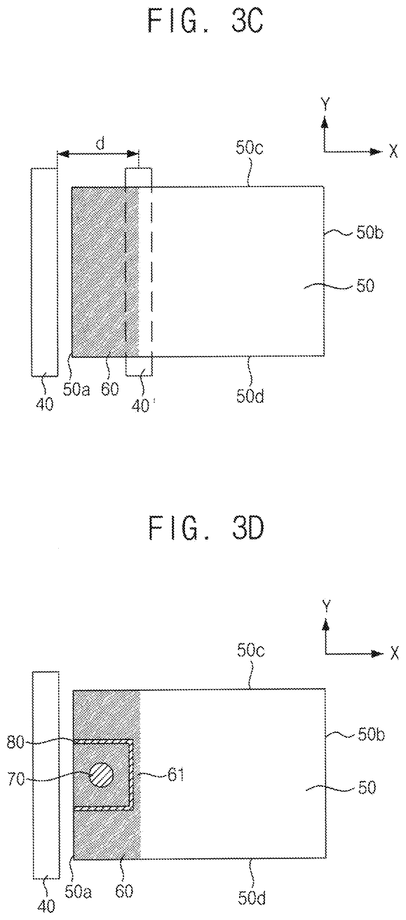

FIG. 3A, FIG. 3B, FIG. 3C, FIG. 3D, FIG. 4A, FIG. 4B, FIG. 4C and FIG. 4D are process views illustrating a three-dimensional printing method using the printer in FIG. 2.

Hereinafter, referring to FIGS. 3A to 3D, and FIGS. 4A to 4D, the three-dimensional printing method (hereinafter, printing method) using the printer is explained. The printing method substantially means the method for manufacturing the three-dimensional structure.

Here, in FIGS. 3A to 3D, the printer of FIG. 2 is partially illustrated.

For example, in FIGS. 3A to 3D, fourth side surfaces 50a, 50b, 50c and 50d covering the bed 50 are illustrated, and the disposition of the scraper 40 which is disposed adjacent to a first side surface 50a of the bed 50 is illustrated. The devices of the laser 10, 11 and 15, the material supplier 21 and the material collector 23 are omitted for the convenience of the explanation.

In addition, in FIGS. 4A to 4D, side views of the printer of FIG. 2 is partially illustrated. For the convenience of the explanation, the devices of the laser 10, 11 and 15, the material supplier 21 and the material collector 23 are omitted, too. However, one ordinary skilled in the art may understand that the material supplier 21 discharges the predetermined amount of the powder material between a waiting position of the scraper 40 and the bed 50, at every process of integrating the powder material 60 on the bed 50.

First, referring to FIG. 3A and FIG. 4A, the scraper 40 integrates the powder material 60 on a partial area of the bed 50. As illustrated, the scraper 40 moves from an initial waiting position toward a return position which is spaced apart from the initial waiting position by a predetermined distance d, and then the scraper 40 returns to the initial waiting position. Here, the initial waiting position is the position of the scraper 40 shown as a solid line in the figure, and the return position is the position of the scraper 40 shown as a dotted line in the figure. Thus, the powder material 60 is integrated in a partial area of the bed 50 instead of being integrated in a whole area of the bed 50.

The, as illustrated in FIG. 3B and FIG. 4B, the laser irradiation device 15 irradiates the laser L to the powder material 60, to sinter the powder material 60, so that the two-dimensional structure 70 and the wall layer 80 are formed. Here, the two-dimensional structure 70 is a sliced shape taking the three-dimensional structure along a horizontal line or a horizontal surface. The two-dimensional structure 70 substantially has a thickness corresponding to a height of the integrated powder material 60 and thus has a three-dimensional shape, but the two-dimensional structure 70 is used to distinguish the three-dimensional structure which is a finally manufactured structure, for the convenience of the explanation.

In the present example embodiment, the wall layer 80 is disposed adjacent to the three-dimensional structure by a predetermined distance, for example several millimeters (mm) to several centimeters (cm), to prevent the integration of the powder material 60 from being collapsed. The wall layer 80 is spaced apart from the structure 70 along the horizontal direction by a predetermined distance, to enclose at least one surface of the structure 70. For example, as illustrated in FIG. 3B, the wall layer 80 may enclose three surfaces of the structure 70 except for the first surface side 50a of the bed 50. Accordingly, the wall layer 80 is formed to enclose the structure 70, so that the wall layer 80 divides the integrated area of the bed 50 into the un-integrated area of the bed 50 and the powder material 60 is integrated around the structure 70 more uniformly and flat.

Here, the three-dimensional structure 70 may be positioned adjacent to the first side 50a of the bed 50 closer to the waiting position of the scraper 40 instead of being positioned at a center of the bed 50. Here, the wall layer 80 may be disposed much closer to the structure 70, and the thickness, the shape or the position of the wall layer 80 may be variously changed. When the three-dimensional structure 70 is completed, the wall layer 80 is divided from the base plate 30 and is discarded. Thus, the width of the wall layer 80 should be narrower as possible as it can, to decrease an amount of the irradiated laser and to decrease an amount of the discarded powder material.

For example, the width of the wall layer 80 may be about 1 mm, and the width of the wall layer 80 may be variously changed.

Since it is enough for the scraper 40 to integrate the powder material 60 from the first side surface 50a to the wall layer 80 uniformly and flat, the scraper 40 may return back right after passing through the wall layer 80 or after moving toward a predetermined position passing through the wall layer 80, and the returning position may be variously changed.

Generally, the powder material once used may be reused again, but the powder material may be oxidized or damaged as the reused number of the powder material increases, and thus the amount of the powder material reused should be decreased. Thus, to decrease the amount of the powder material 61 integrated in an outer area of the wall layer 80, the returned position of the scraper 40 may be determined at a position right after passing through the upper surface of the wall layer 80. Thus, the amount of the powder material 61 in the outer area of the wall layer 80 may be decreased more efficiently.

The position of the structure 70 inside of the bed 50, the shape of the wall layer 80 enclosing the structure 70, and the returned position of the scraper 40 may be predetermined by the controller.

For example, the controller may determine the position of the structure 70 inside of the bed 50, based on the size of the three-dimensional structure 70, and then based on the position of the structure 70, the controller may determine the shape and the position of the wall layer 80. Then, the controller may determine the returned position of the scraper 40 according to the position of the wall layer 80. In addition, when the returned position of the scraper 40, the moving distance d of the scraper 40 is determined. Thus, the material supplier 21 may determine the amount of the powder material at every step, based on the moving distance d of the scraper 40.

Accordingly, when the single layer integration of the powder material and the sintering are finished, as illustrated in FIG. 3C and FIG. 4C, the base plate 30 descends by a predetermined height, for example between about 30 μm and about 50 μm and new layer of the powder material 60 is integrated at a partial area of the bed 50. In FIG. 3C, the scraper 40 starts at the initial waiting position and returns at the returned position (the dotted line of the scraper 40′ in the figure), and thus the powder material is integrated in the partial area of the bed 50.

Then, as illustrated in FIG. 3D and FIG. 4D, the laser irradiation device 15 irradiates the laser L to the powder material 60 to sinter the powder material 60, and then the structure 70 and the wall layer 80 are formed. The above integration and the sintering are repeated, to form the three-dimensional structure and the wall layer 80 having the same height with the structure and enclosing the structure, finally.

According to the above-mentioned example embodiment, the manufactured three-dimensional structure 70 is positioned adjacent to the first side surface 50a of the bed, as close as possible, which is close to the waiting position of the scraper 40, instead of the center of the bed 50. In addition, the powder material is integrated only on the structure 70 and the wall layer 80 enclosing the structure 70. Thus, the powder material are unnecessary to be integrated on an whole area of the bed 50 in manufacturing the three-dimensional structure, and thus the powder material may not be wasted and the moving distance of the scraper 40 may be decreased to improve the productivity of the structure.

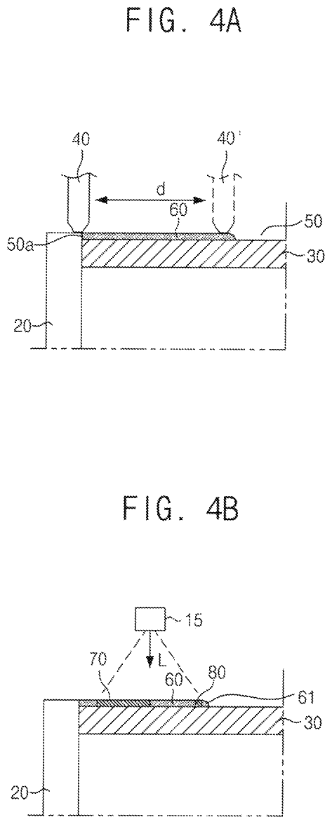

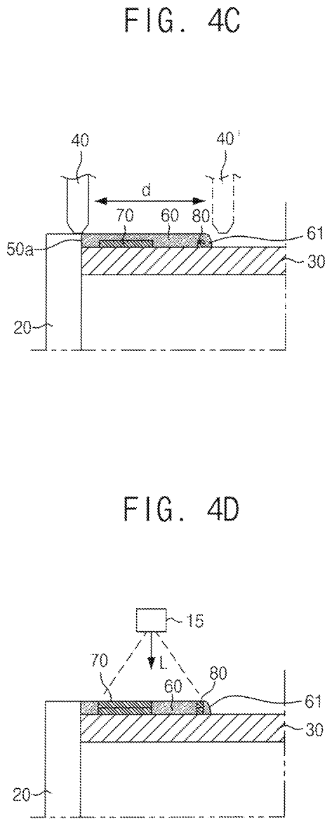

FIG. 5 and FIG. 6 are plan views illustrating an example disposition of a structure and a wall layer, in a three-dimensional printing method using a three-dimensional printer according to another example embodiment of the present invention.

For example, when the single three-dimensional structure 70 having a relatively small size is manufactured, as illustrated in FIG. 5, the structure 70 may be formed at a corner of the bed 50. The structure 70 is disposed adjacent to both side surfaces of the bed 50 adjacent to each other, such as the first and third side surfaces 50a and 50c, which is close to the waiting position of the scraper 40, and the wall layer 80 is formed to enclose two side surfaces of the structure 70.

Alternatively, when a plurality of three-dimensional structures having a relatively small size is manufactured, as illustrated in FIG. 6, the plurality of structures 71, 72 and 73 is disposed adjacent to the first side surface 50a of the bed 50 close to the waiting position of the scraper 40, and the wall layer 80 is formed to block the side surface of the plurality of the structures 71, 72 and 73.

Accordingly, the structure is positioned at a proper position of the bed 50 close to the scraper 40 as possible as it can, according to the size and the number of the manufactured structure 70, and then the shape and the position of the wall layer 80 may be determined. In addition, after the position and the shape of the structure 70 and the wall layer 80 are determined, the arbitrary position passing through the wall layer 80 is determined as the returned positon of the scraper 40, and thus the moving distance d of the scraper may be minimized

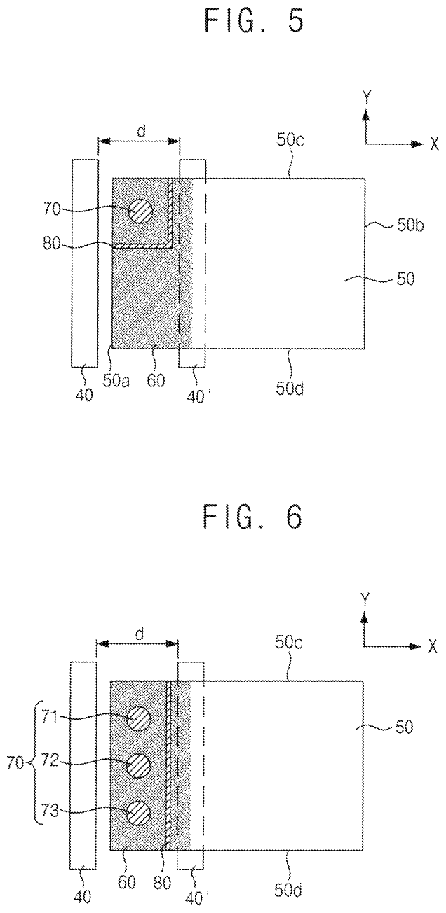

FIG. 7A is a plan view illustrating a wall layer in a three-dimensional printing method using a three-dimensional printer according to still another example embodiment of the present invention, and FIG. 7B is an enlarged view illustrating a portion ‘A’ of FIG. 7A.

In the present example embodiment, the wall layer 80 has a grid shape in a plan view. The wall layer 80 includes a plurality of first direction layers 810 formed along a Y direction, and a plurality of second direction layers 820 formed along an X direction substantially perpendicular to the Y direction, and thus the wall layer 80 is formed as the grid shape.

Due to the structure of the wall layer, the laser is not irradiated to the area 830 between the grids adjacent to each other, and the wall layer is also not formed and thus the powder material 60 remains without the sintering. Thus, the remained powder material 60 may be reused, and in the present example embodiment, the amount of the powder material used may be minimized and the effect due to the formation of the wall layer 80 may be obtained.

In addition, in the present example embodiment, the wall layer is formed to be the grid shape, but alternatively, the wall layer may be formed to have an arbitrary shape having a vacant space inside therein such as a honeycomb structure.

As explained in FIGS. 3A to 3D, and FIGS. 4A to 4D, the amount of the powder material 61 integrated in the outer area of the wall layer 80, which is the powder material integrated between the wall layer 80 and the second side surface 50b of the bed 50, should be decreased as possible as it can, and thus the returned position of the scraper 40 may be predetermined at the position right after passing through the upper surface of the wall layer 80. However, as the returned position is closer to the wall layer 80, the height of the upper portion of the wall layer 80 from the bottom of the bed 50 is increased at the outer area of the wall layer 80 as the integration repeated, and thus the power material 61 may be integrated with a steep slope at the outer area of the wall layer 80 and then the power material 60 may be collapsed rapidly. Then, the wall layer 80 is hard to be integrated at the next turn. Here, the wall layer 80 should be properly and stably formed to maintain the powder material 60 uniformly and flat inside of the wall layer 80, to prevent the three-dimensional structure 70 from being misformed. Thus, the amount of the powder material 61 at the outer area of the wall layer 80 should be decreased as possible as it can, or the method or the process not to affect the formation of the wall layer 80 should be considered.

Thus, hereinafter, the example embodiments to solve the above-mentioned problem are explained.

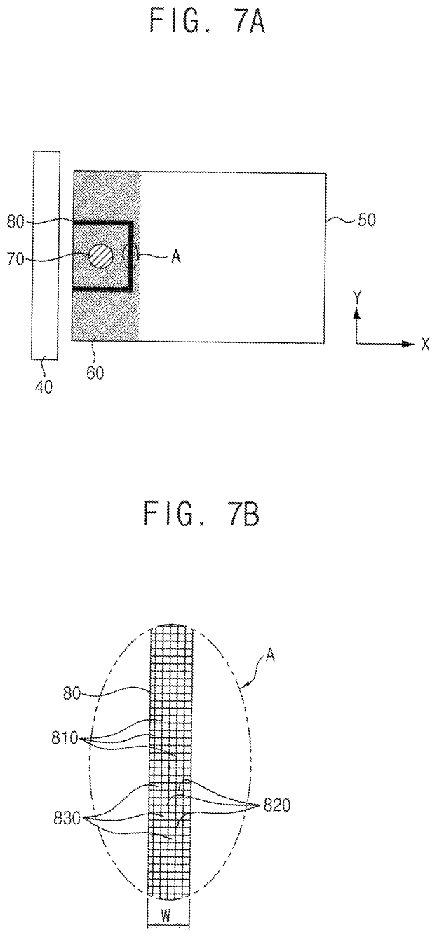

FIG. 8A is a plan view and FIG. 8B is a side view illustrating a three-dimensional printing method using a three-dimensional printer according to still another example embodiment of the present invention.

Here, FIG. 8A partially shows the printer in a plan view, and FIG. 8B partially shows the printer in a side view.

In the present example embodiment, to prevent the powder material 60 from being collapse at the outer area of the wall layer 80, the wall layer 80 is formed at the position adjacent to the three-dimensional structure 70 by a predetermined distance, and in addition, an additional wall layer 81 is formed at the outer area of the wall layer 80. The position of the additional wall layer 81 is at the outer area of the wall layer 80, which means that the wall layer 80 is disposed between the additional wall layer 81 and the structure 70 or the additional wall layer 81 is disposed between the wall layer 80 and the second side surface 50b of the bed 50.

Here, the additional wall layer 81 may be spaced apart from the wall layer 80 by between about 50 mm and about 10 mm, and the width of the additional wall layer 81 may be about 1 mm. However, the shape, the length, the width and so on of the additional wall layer 81 may be variously changed.

Here, the returned positon of the scraper 40 may be disposed at the position passing through the additional wall layer 81. For example, the scraper 40 returns right after passing through the additional wall layer 81 or returns from the position disposed at an arbitrary position passing through the additional wall layer 81.

According to the present example embodiment, as the structure 70, the wall layer 80 and the additional wall layer 81 are gradually integrated, even though the powder material 61 integrated at the outer area of the additional wall layer 81 is integrated with a steep slope and the integration is collapse, the additional wall layer 81 is only affected by the collapse and the powder material 60 integrated inside of the wall layer 80 are integrated uniformly and flat.

In addition, for manufacturing the structure 70 having a relatively high height, at least two additional wall layers 81 may be formed.

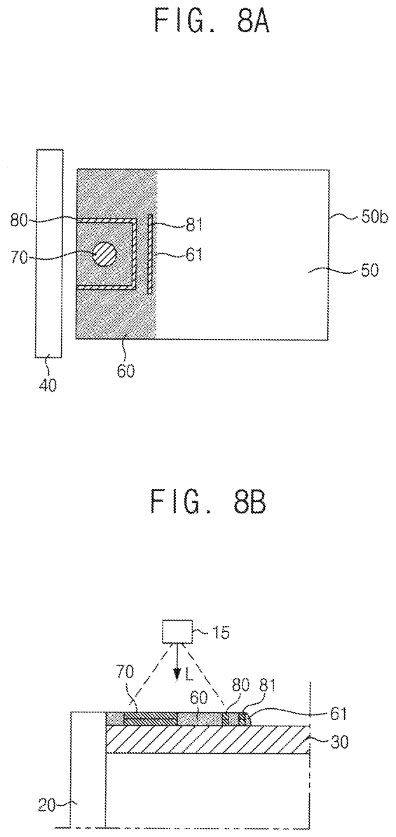

FIG. 9 is a plan view illustrating a three-dimensional structure and a wall layer, in a three-dimensional printing method using a three-dimensional printer according to still another example embodiment of the present invention.

FIG. 9 shows a second additional wall layer 81b formed at the outer area of a first additional wall layer 81a. Here, even though the powder material 61 outside of the second additional wall layer 81b is integrated with a steep slope and the integration is partially collapsed, at least two wall layers 80a and 81a functions as a buffer and the powder material 60 inside of the wall layer 80 is integrated uniformly and flat. Thus, the shape or the number of the additional wall layers 81 may be variously changed, according to the height of the integration of the structure 70.

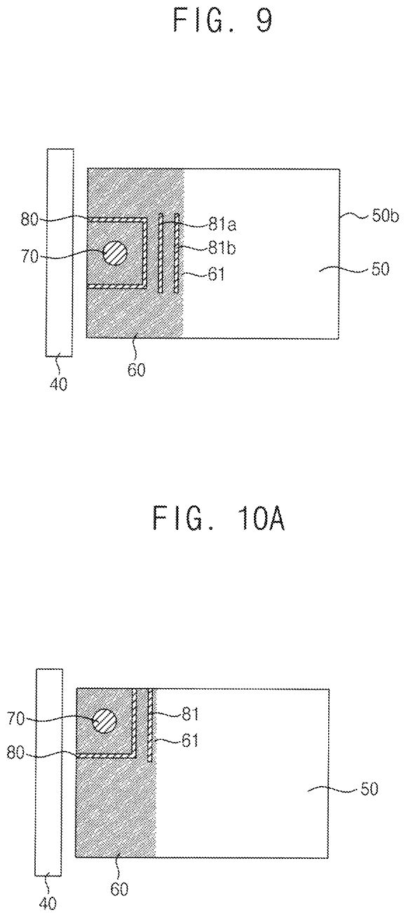

FIG. 10A and FIG. 10B are plan views illustrating a three-dimensional structure and a wall layer, in a three-dimensional printing method using a three-dimensional printer according to still another example embodiment of the present invention.

FIG. 10A shows an additional wall layer 81 additionally formed at the previous example embodiment of FIG. 5, FIG. 10B shows an additional wall layer 81 additional formed at the previous example embodiment of FIG. 6, and as illustrated, the shape, the length, or the number of the additional wall layers 81 may be variously changed according to the size or the number of the structure 70 manufactured.

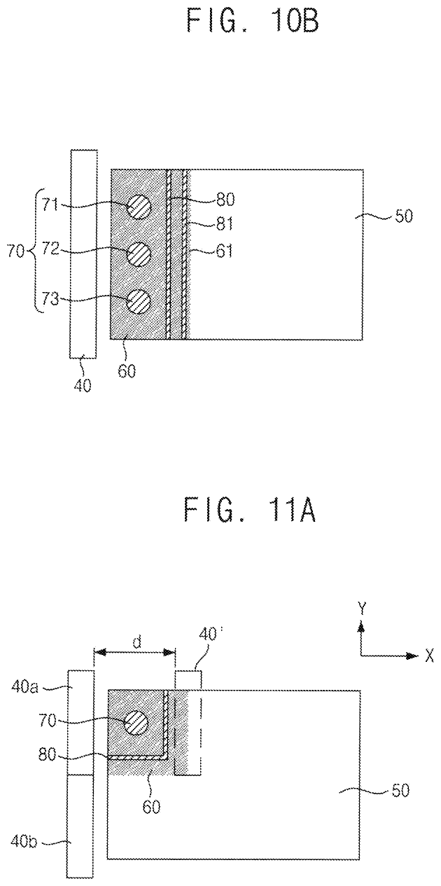

FIG. 11A and FIG. 11B are plan views illustrating a three-dimensional printing method using a three-dimensional printer according to still another example embodiment of the present invention.

Referring to FIG. 11A, in the present example embodiment, the scraper is divided into two scrapers 40a and 40b according to an advancing direction (X direction) of the scraper. In addition, although not shown in the figure, the lifting part 22 inside of the material supplier 21 may be also divided into two parts correspond to the division of the scraper.

In the present example embodiment, when the three-dimensional structure 70 having a relatively small size is manufactured, as illustrated in the figure, the first scraper 40a is only operated to form the structure 70 and thus the powder material 60 is saved. Here, although the scraper is divided into two parts, but the scraper may be divided into more than three parts if necessary, and thus the lifting parts 22 of the material supplier 21 may also be divided into more than three parts.

In addition, as illustrated in FIG. 11B, the additional wall layer 81 may be also formed. In the present example embodiment, the wall layer 80 is formed over the areas heading two side surfaces 50b and 50d of the bed 50, and thus, as illustrated in the figure, the additional wall layer 81 is also formed along the above two directions. Thus, the powder material 60 inside of the wall layer 80 may be integrated uniformly and flat.

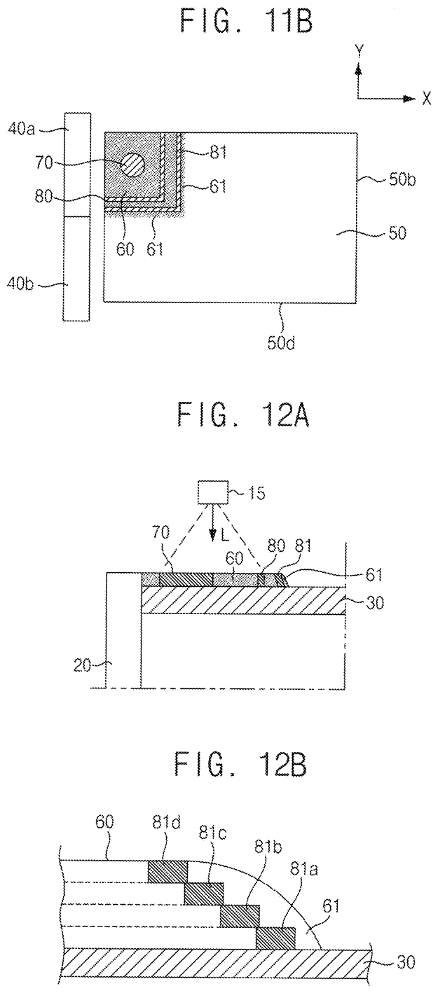

FIG. 12A is a side view illustrating a three-dimensional structure and a wall layer in a three-dimensional printing method using a three-dimensional printer according to still another example embodiment of the present invention, and FIG. 12B is an enlarged view illustrating the wall layer of FIG. 12A.

Referring to FIG. 12A, in the present example embodiment, the wall layer 80 and the additional wall layer 81 are formed the same as explained referring to FIG. 8B. However, in the present example embodiment, when the additional wall layer 81 is formed, the additional wall layer 81 is inclined to be an inside (inclined toward the wall layer 80) as the height of the additional wall layer 81 increases. The wall layer 80 is integrated vertically, but the additional wall layer 81 is integrated toward the structure 70 at every layer, and thus the additional wall layer 81 is inclined toward the structure 70. Thus, in the present example embodiment, the powder material 61 outside of the additional wall layer 81 is integrated with relatively less steep, and the amount of the powder material 61 discarded may be decreased.

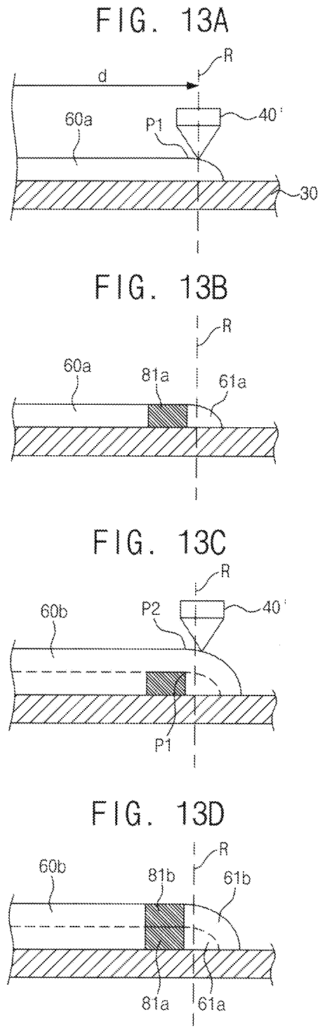

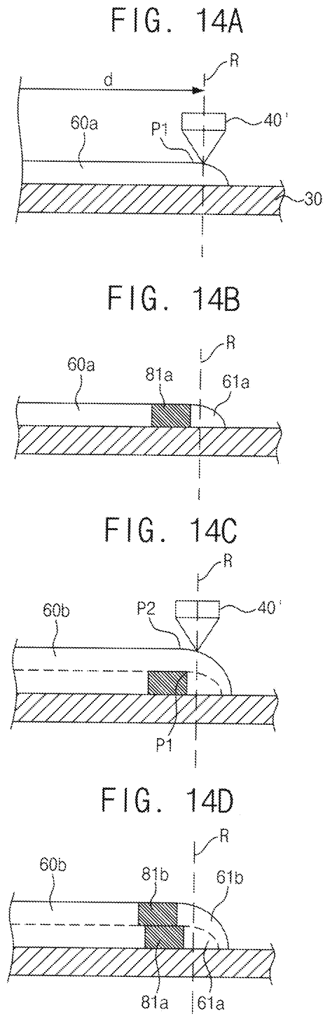

FIGS. 13A to 13D show an example of integrating the wall layer vertically, and FIGS. 14A to 14D show an example of integrating the wall layer inclined inwardly.

FIG. 13A, FIG. 13B, FIG. 13C and FIG. 13D are process views illustrating an example method for integrating the wall layer, in the three-dimensional printing method in FIG. 12A and FIG. 12B.

Referring to FIG. 13A, a first layer of power material 60a is integrated on the base plate 30. Here, the scraper 40′ moves from the initial waiting position to the returned position R spaced apart from the initial waiting position by a distance d, to integrate the powder material 60a uniformly. The member supporting the powder material 60a is not disposed at an outermost side of the powder material 60a (a right side in the figure), and thus the powder material 60a at the outermost side is collapsed slightly. For example, the powder material is uniformly integrated until a first position P1 little inside of the returned position R, but the height of the powder material is decreased and the powder is inclined after passing through the first position P1.

Thus, as illustrated in FIG. 13B, the first layer of additional wall layer 81a having a width until the first position P1 instead of the returned position R is formed, to irradiate the laser for forming the additional wall layer 81.

Then, as illustrated in FIG. 13C, when integrating the second layer of powder material 60b using the scraper, the scraper 40′ should be moved slightly outside of the returned position R (right side in the figure) to maintain the powder material 60b uniformly until the second position P2 substantially same as the first position P1. Then, the laser is irradiated to form the second layer of additional wall layer 81b vertically on the first layer of additional wall layer 81a, as illustrated in FIG. 13D.

Accordingly, to form the additional wall layer 81 vertically, the actual returned position of the scraper should be gradually moved outside of the initial returned position R as the height of the integration of the powder material is increased, to prevent the powder material from being collapsed.

FIG. 14A, FIG. 14B, FIG. 14C and FIG. 14D are process views illustrating another example method for integrating the wall layer, in the three-dimensional printing method in FIG. 12A and FIG. 12B.

Here, FIG. 14A and FIG. 14B are substantially same as FIG. 13A and FIG. 13B, respectively. The scraper 40′ moves from the initial waiting position to the returned position R spaced apart from the initial waiting position by a distance d, to integrate the first layer of powder material 60a. Then, the laser is irradiated to form the first layer of additional wall layer 81a having a predetermined width until the first position P1

The, referring to FIG. 14C, the scraper is returned to the initial returned position R, to integrate the second layer of powder material 60b. Here, the second layer of powder material 60b is uniformly formed until the second position P2 inside (left side in the figure) of the first position P1 until which the first layer of powder material 60a is uniformly formed.

Thus, when forming the second layer of additional wall layer 81b, as illustrated in FIG. 14D, the second layer of additional wall layer 81b is formed inside of the first layer of additional wall layer 81a. Accordingly, the steps of FIG. 14A to FIG. 14D are repeated, so that the additional wall layer 81 is formed inclined inwardly heading for the structure 70.

As compared in FIG. 13D and FIG. 14D, when the additional wall layer 81 is formed inclined inwardly, the amount of the powder material 61 integrated outside may be more decreased. Here, the additional wall layer 81a at a lower layer supports the powder material 61 stacked upwardly, and the returned position R of the scraper 40′ is uniformly maintained even though the height of the integration of the additional wall layer 81 increases.

In addition, in the present example embodiment, as the height of the integration is increased, the actual returned positon of the scraper is moved inwardly (heading for the structure 70) from the initial returned position R, so that the additional wall layer 81 inclined more may be formed and the amount of the powder materials 61 at the outer area may be more decreased.

For example, as illustrated in FIG. 12B, with a contact area between the additional wall layer downside and the additional wall layer upside being minimized as possible as it can, each layer 81a to 81d of the additional wall layer are integrated, so that the amount of the powder material 61 at the outer area of the additional wall layer 81 may be greatly decreased.

The example embodiments referring to FIGS. 12A to 14D are explained as forming the additional wall layer 81 to be inclined. In the example embodiment of forming the wall layer 80 without the additional wall layer 81, the wall layer 80 may be formed to be inclined heading for the structure 70. Further, in the example embodiment of forming at least two additional wall layers 81, the outermost additional wall layer may be formed to be inclined as explained above.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A three-dimensional printing method using a three-dimensional printer, the method comprising:
integrating a powder material on a partial area of a bed of the printer;
irradiating a laser to the integrated powder material based on a two-dimensional shape information of a manufactured structure, to sinter a two-dimensional structure and a first wall layer; and
repeating the integrating and the irradiating, to form a three-dimensional structure and the first wall layer,
wherein the first wall layer is disposed to divide the partial area of the bed into a remaining area of the bed except for the partial area of the bed.

2. The method of claim 1, wherein the integrating comprises:
moving a scraper to be a round trip from a predetermined waiting position to a predetermined return position (round trip distance, d) passing through the first wall layer,
wherein the scraper coats the powder material on the bed.

3. The method of claim 2, wherein before the integrating, further comprising:
discharging a predetermined amount of the powder material between the waiting position of the scraper and the bed, from a material supplier,
wherein the predetermined amount of the powder material is determined based on the round trip distance d of the scraper.

4. The method of claim 1, wherein the first wall layer is formed to enclose at least two side surfaces of the three-dimensional structure.

5. The method of claim 1, wherein the first wall layer has a grid shape in a plan view, and the powder material is filled in a space of the grid shape.

6. The method of claim 1, wherein the first wall layer becomes inclined toward the three-dimensional structure as a height of the first wall layer goes up, when forming the first wall layer.

7. The method of claim 1, wherein a second wall layer is formed with the three-dimensional structure and the first wall layer at the same time,
wherein the second wall layer is adjacent to the first wall layer, and the first wall layer is disposed between the second wall layer and the three-dimensional structure.

8. The method of claim 7, wherein the second wall layer becomes inclined toward the first wall layer as a height of the second wall layer goes up, when forming the second wall layer.

9. A three-dimensional printer for forming a three-dimensional structure, the printer comprising:
a bed configured to be enclosed by a liftable based plate and a sidewall of a body of the printer;
a material supplier configured to supply a powder material to the bed;
a scraper configured to integrate the powder material from the material supplier on the bed;
a laser irradiation device configured to irradiate the powder material integrated on the bed, to sinter the powder material; and
a controller configured to control the scraper and the laser irradiation device,
wherein the controller controls the scraper and the laser irradiation device, such that the powder material is integrated on a partial area of the bed and the laser is irradiated to the integrated powder material, to form a three-dimensional structure and a first wall layer,
wherein the first wall layer is disposed to divide the partial area of the bed into a remaining area of the bed except for the partial area of the bed.

10. The printer of claim 9, wherein the controller controls such that the scraper moves to be a round trip from a predetermined waiting position to a predetermined return position (round trip distance, d) passing through the first wall layer.

11. The printer of claim 10, wherein the controller controls such that the material supplier determines the predetermined amount of the powder material based on the round trip distance d of the scraper.

12. The printer of claim 9, wherein the first wall layer is formed to enclose at least two side surfaces of the three-dimensional structure.

13. The printer of claim 9, wherein the first wall layer has a grid shape in a plan view, and the powder material is filled in a space of the grid shape.

14. The printer of claim 9, wherein the controller controls such that a second wall layer is formed with the three-dimensional structure and the first wall layer at the same time,
wherein the second wall layer is adjacent to the first wall layer, and the first wall layer is disposed between the second wall layer and the three-dimensional structure.

15. The printer of claim 14, wherein the second wall layer becomes inclined toward the first wall layer as a height of the second wall layer goes up.
